(19) United States
(12) Patent Application Publication
(10) Pub. No.: US 2026/0201846 A1
(43) Pub. Date: Jul. 16, 2026

(54) FUELING SYSTEM CONTROLS INCLUDING DETECTION OF VALVE FULLY OPEN CONDITION

(71) Applicant: Cummins Inc., Columbus, IN (US)

(72) Inventors: Edward Benjamin Manring, Edinburgh, IN (US); Timothy J. Viola, Columbus, IN (US)

(21) Appl. No.: 19/127,758

(22) PCT Filed: Nov. 14, 2023
(86) PCT No.: PCT/US2023/079605

§ 371 Date: May 7, 2025

Related U.S. Application Data
(60) Provisional application No. 63/383,941, filed on Nov. 16, 2022.

(51) Int. Cl. F02D 19/06; F02D 41/20

(52) U.S. Cl. CPC F02D 19/061; F02D 19/0626; F02D 19/0644; F02D 19/0647; F02D 19/0689; F02D 41/20

(57) ABSTRACT

A process of operating a computing system in operative communication with a fueling system including includes receiving a fueling command including a specified fuel quantity and a specified fuel pressure, determining a first fueling rate shape corresponding to the specified fuel pressure but not corresponding to the specified fuel quantity, determining a second fueling rate shape corresponding to the specified fuel quantity and the specified fuel pressure at least in part by modifying the first fueling rate shape by repositioning a post-maximum fueling portion of the first fueling rate shape relative to a pre-maximum fueling portion of the first fueling rate shape, updating a fuel metering device control model based on the second fueling rate shape, and at least one of controlling and diagnosing a fuel metering device of the fueling system using the updated fuel metering device control model.

### CROSS REFERENCE

The present application claims priority to and the benefit of U.S. Application No. 63/383,941 filed Nov. 16, 2022, and the same is hereby incorporated by reference.

### TECHNICAL FIELD

The present application relates to fueling system controls including detection of valve fully open condition.

### BACKGROUND

Controls for fueling systems for internal combustion engines suffer from a number of shortcomings including those respecting accuracy, complexity, computational burden, dedicated hardware requirements, precision, reliability, and robustness, among other shortcomings. There remains a significant need for the unique apparatuses, processes, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

One embodiment includes unique fueling system controls. In some forms the fueling system control may include detection of valve fully open condition. Further embodiments include unique apparatuses, systems, and processes comprising or embodying such controls. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example engine system including an example fueling system.

FIG. 2 is a flow diagram illustrating certain aspects of an example process.

FIG. 3 is a diagram illustrating certain aspects of example controls.

FIGS. 4 and 5 are graphs illustrating certain aspects of an example control process and example controls.

### DETAILED DESCRIPTION OF EXAMPLE EMBODIMENTS

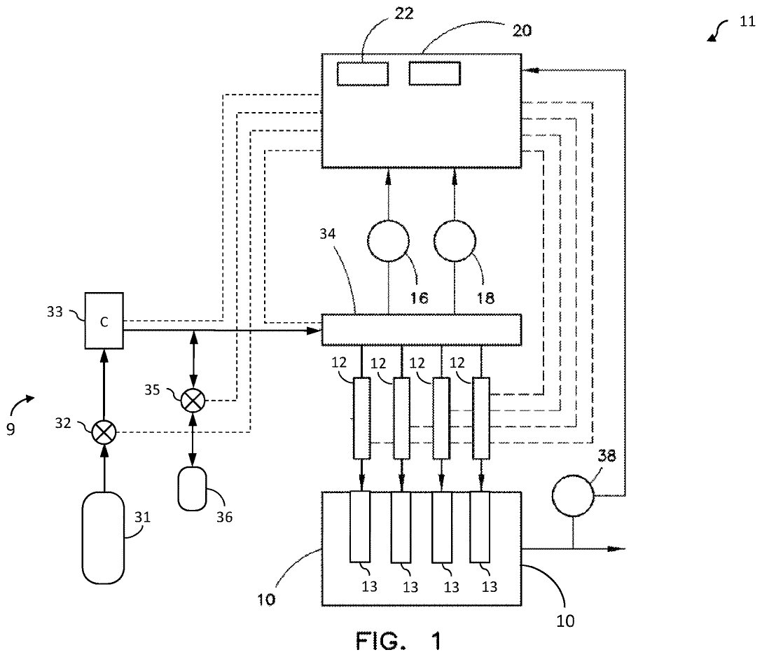

With reference to FIG. 1, there is illustrated a system 11 comprising an engine 10 and a fueling system 9. In the illustrated embodiment, engine 10 is provided as an internal combustion engine configured to combust gaseous fuel provided by fueling system 9, such as natural gas, hydrogen, or other gaseous fuels. In other embodiments, fueling system 9 and engine 10 may be configured to provide and combust other types of fuels such as diesel fuel, gasoline, or other liquid fuels. Engine 10 comprises combustion chambers 13 of a reciprocating piston-in cylinder type which are configured to generate mechanical power from the combustion of fuel. The fuel injectors 12 are in fluid communication with respective combustion chambers of the engine 10 and are structured to introduce the fuel into respective combustion chambers. In the illustrated embodiment, fuel injectors 12 are configured and provided as fuel injectors of a port-injected fueling system configured to inject fuel into intake ports leading to respective combustion chambers 13 of engine 10, although other embodiments may include other types and configurations of injectors such as direct fuel injectors configured to inject fuel directly into respective combustion chambers 13 of engine 10. In the illustrated embodiment, four fuel injectors 12 and four combustion chambers 13 are depicted, it being appreciated that engine 10 may include fewer or greater numbers of fuel injectors 12 and combustion chambers 13. System 11 may be provided in a number of forms including as a prime mover system (or component of a prime mover system) of vehicle, a genset, other power-load system.

In the illustrated embodiment, the fueling system 9 is configured and provided as a pressurized gaseous fueling system. Fueling system 9 includes a fuel tank 31 configured to store a supply of gaseous fuel, such as natural gas. The fuel tank 31 is flow coupled to a compressor 33 via a control valve 32 which is actuatable by electronic control system (ECS) 20 to control a flow of gaseous fuel to compressor 33. Compressor 33 is configured to compress gaseous fuel received from fuel tank 31 via valve 32 and supply compressed gaseous fuel to pressure regulator 34 and/or accumulator 36. Accumulator 36 is configured to provide a reservoir of pressurized gaseous fuel received from compressor 33 and may be selectably coupled and decoupled from a line supplying fuel from compressor 34 to fuel conditioner 34 by valve 35 which is actuatable by ECS 20 to control a flow of gaseous fuel to or from accumulator 36. Pressure regulator 34 is configured to control the pressure of gaseous fuel supplied to the fuel injectors 12 and may perform such control operations in response to control signals from ECS 20.

It shall be appreciated that the illustrated form of fueling system 9 is but one example of a fueling system according to the present disclosure. In other embodiments, the fueling system 9 may be configured and provided as another type of gaseous fueling system, for example, as a gaseous hydrogen direct injection fueling system. In other embodiments, fueling system 9 may be configured and provided in other forms, for example, as a high-pressure common-rail diesel fuel injection system or other types of fueling systems.

System 11 further includes electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 include at least one electronic control unit (ECU) 22 configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the system 11. For example, the sensors may include a pressure sensor 16 and a temperature sensor 18. The pressure sensor 16 is in communication with the pressure regulator 34 and structured to communicate a measurement of the pressure within the pressure regulator 34 to the ECS 20. The temperature sensor 18 is in communication with the pressure regulator 34 and structured to communicate a measurement of the temperature within the pressure regulator 34 to the ECS 20. In at least one embodiment, system 11 may include an oxygen sensor 38 (e.g., a lambda sensor) in communication with the ECS 20 and structured to determine characteristics of exhaust gases generated and expelled by the engine 10. In one example, oxygen sensor 38 may determine the concentration of oxygen in the exhaust gases as a proxy for the concentration of regulated emissions.

As will be appreciated by the description that follows, the techniques described herein relating to fuel injector or fuel injection parameters can be implemented in ECS 20, which may include one or more controllers for controlling different aspects of the system 11. In one form the ECS 20 comprises one or more electronic control units (ECU) such as an engine control unit or engine control module. The ECS 20 may be comprised of digital circuitry, analog circuitry, or a hybrid combination of both of these types. Also, the ECS 20 may be programmable, an integrated state machine, or a hybrid combination thereof. The ECS 20 may include one or more Arithmetic Logic Units (ALUs), Central Processing Units (CPUs), memories, limiters, conditioners, filters, format converters, or the like which are not shown to preserve clarity. In one form, the ECS 20 is of a programmable variety that executes algorithms and processes data in accordance with operating logic that is defined by programming instructions (such as software or firmware). Alternatively or additionally, operating logic for the ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 11. As used herein, the term sensors may include any suitable hardware and/or software used to sense or estimate any engine system parameter and/or various combinations of such parameters either directly or indirectly.

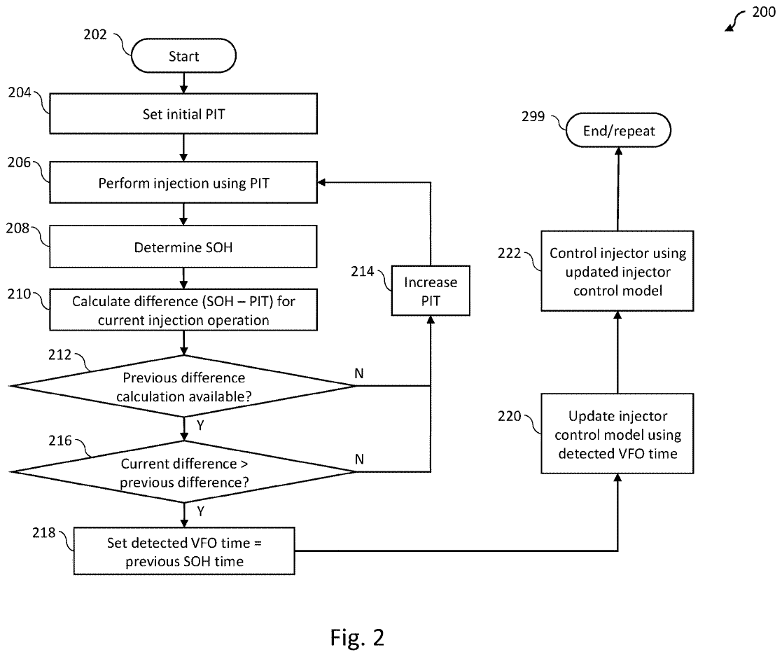

With reference to FIG. 2, there is illustrated an example process 200 for operating an electronic control system (e.g., ECS 20 or another electronic control system), in operative communication with a fueling system (e.g., fueling system 9 or another fueling system). Process 200 may be implemented in and performed by one or more components of an electronic control system such as one or more electronic control units (e.g., ECU 22 and/or other electronic control units) and/or by other electronic control system components.

Process 200 begins at start operation 202 and proceeds to operation 204 which sets an initial value of a pull-in time (PIT). The PIT may be provided and utilized as part of an injector control command (ICC) utilized in controlling operation of an injector. The ICC may also include or be associated with other injector control parameters such as injector on time (IOT) or other injector control parameters.

From operation 204, process 200 proceeds operation 206 which controls an injector to perform an injection using the PIT command. In some embodiments, operation 206 may include generating an ICC with a controller implemented in one or more electronic control units and providing an ICC to injector driver circuitry including a feedback controller which is configured and operable to control a fuel injector in accordance with the ICC. In other embodiments, operation 206 may include or utilize additional or alternative operations and techniques.

From operation 206, process 200 proceeds to operation 208 which receives a start of hold time (SOH) in response to the injection performed at operation 206. In some embodiments, operation 208 may include receiving the SOH as a feedback signal from the feedback controller which may be received and stored in a register or other non-transitory memory medium of an electronic control unit. In other embodiments, operation 208 may include or utilize additional or alternative operations and techniques.

From operation 208, process 200 proceeds to operation 210 which calculates a difference between the start of hold time and the pull-in time (SOH-PIT) for the current injection operation performed at operation 206. In some embodiments, operation 210 may calculate the difference by subtracting the PIT from the SOH and storing the resulting difference in a non-transitory memory medium of an electronic control unit. In other embodiments, operation 208 may include or utilize additional or alternative operations and techniques for calculating or determining the difference.

From operation 210, process 200 proceeds to conditional 212 which evaluates whether a previous difference calculation is available. Conditional 212 may evaluate whether a previous difference calculation is available by checking one or more non-transitory memory locations for the presence of previous difference calculation, checking a counter indicating an number of executions or iterations of operation 210 and/or other operations of process 200, or by using a combination of the foregoing and/or other operations and techniques.

If conditional 212 evaluates negative, process 200 proceeds to operation 214 which increases the PIT. Operation 214 may increase the PIT by a predetermined value and store the increased value of PIT in one or more non-transitory memory locations. The predetermined value may be established during commissioning, calibration or servicing of a system such as system 11 or a constituent portion thereof. The predetermined value may be on the order of tenths of a millisecond (0.1 ms) or may be of a greater or lesser order. From operation 214, process 200 proceeds to operation 206 and continues as described above.

If conditional 212 evaluates affirmative, process 200 proceeds to conditional 216 which evaluates whether the current difference calculated at operation 210 is greater than the previous difference determined to be available at conditional 212, or whether the current difference is related to previous differences by some other criteria according to a predetermined pattern. In some embodiments, conditional 212 may evaluate this difference using a greater than operator. In other embodiments, conditional 212 may evaluate this difference using other operators such as a less than operator, a greater than or equal to operator, a less than or equal to operator, a comparator or other operators or logic.

If conditional 216 evaluates negative, process 200 proceeds to operation 214 which increases the PIT as described above. From operation 214, process 200 proceeds to operation 206 and continues as described above.

If conditional 212 evaluates affirmative, process 200 proceeds to operation 218 which determines a valve fully open time (VFO) in response to the result of the evaluation performed by conditional 216. Operation 218 may also be considered to determine the VFO in response to the previous SOH and/or response to the previous difference calculation. In the illustrated embodiment, operation 218 determines the VFO by setting the VFO to equal the previous SOH. In other embodiment, operation 218 may determine the VFO by setting the VFO to equal to other values such as a value offset, scaled or otherwise adjusted from the SOH value.

From operation 218, process 200 proceeds to operation 220 which updates an injector control model using the detected VFO. The injector control model may comprise a lookup table, a response surface, or another type of data structure. The injector control model may be configured and operable to determine, output and/or otherwise provide an injector control command (ICC), or a portion or parameter of an ICC, in response to a fueling command. The ICC may include an injector on time, a PIT, and/or other parameters for controlling operation of a fuel injector. The fueling command may include a fueling quantity, a fueling pressure, and/or other parameters for commanding or requesting fueling of an engine.

From operation 220, process 200 proceeds to operation 222 controls operation of the fuel injector using the updated injector control model. Operation 222 may control operation of the fuel injector to perform an injection of fuel to a combustion chamber of an engine. The injection of fuel to a combustion chamber of an engine may be performed to propel a vehicle or to power another load driven by an engine.

From operation 221, process 200 proceeds to operation 299 where process 200 ends and may later be repeated.

It shall be appreciated that a process 200 may be performed individually for each of a plurality of injectors of a fueling system. Process 200 may be performed during normal operation of an engine and associated fueling system to propel a vehicle or power a load and need not require a dedicated calibration or testing mode of operation disruptive of normal operation. Process 200 may be performed a single time or multiple times, for example, as an initial adjustment or configuration of a fueling system and associated electronic control system components, and at later times to re-adjust or re-configure a fueling system and associated electronic control system components. It shall also be appreciated that process 200 may be performed without requiring current level monitoring.

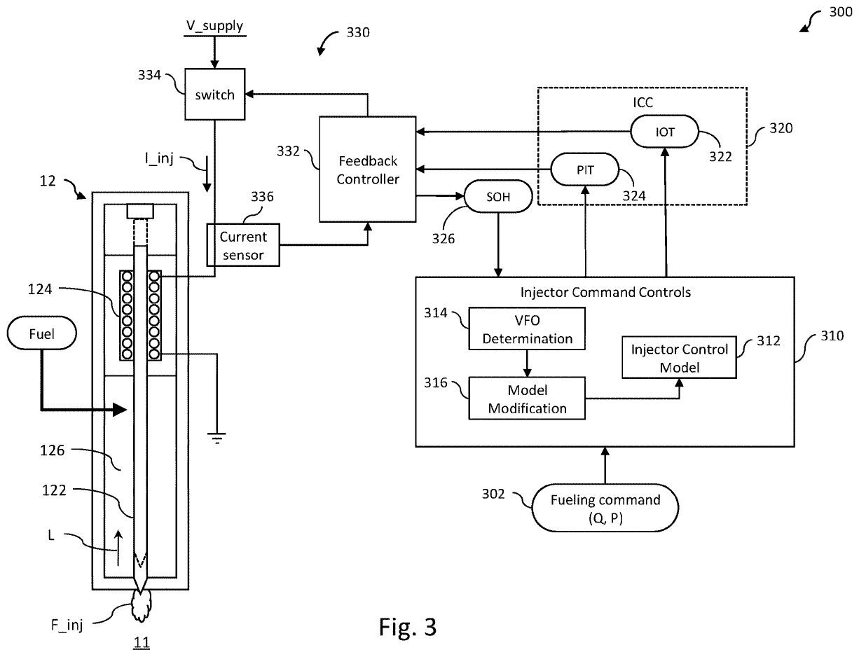

With reference to FIG. 3, there are illustrated example controls 300 which may be implemented in and operated by one or more components of an electronic control system such as ECS 20 or another electronic control system configured for operative communication with a fueling system. In some forms, at least a portion of controls 300 may be implemented in one or mode electronic control units of an electronic control system such as ECU 22 or additional or alternative electronic control units.

Controls 300 include injector command controls 310 which are configured to receive a fueling command 302 and output a command to control an injector in response to the fueling command 302. The fueling command 302 may include a fueling quantity (Q) and a fueling pressure (P). The injector command controls 310 may include an injector control model 312 which is configured and operable to determine a metering device operating command 399 in response to the fueling command 302. The injector control model 312 may comprises a lookup table, a response surface, or another type of data structure. The injector control model 312 may be configured, operable, and/or useable from injector command controls 310 to determine, output and/or otherwise provide an injector control command (ICC) 320, or a portion or parameter of ICC 320, in response to a fueling command. In the illustrated embodiment, the ICC 320 includes an injector on time (IOT) 322 and a pull-in time (PIT) 324. In other embodiments, the ICC 320 may include other parameters for controlling operation of a fuel injector.

Injector command controls 310 further include VFO determination block 314 and model modification block 316 which are configured to participate in determining a VFO and adjusting injector control model 312. In the illustrated example, VFO determination block 314 is configured to determine a VFO by performing one or more of operations such as operation 208, conditional 212, conditional 214, and operation 218 of process 200, or corresponding operations of another process. In the illustrated example, model modification block 316 is configured to update injector control model 312 the VFO determined by block 314.

Controls 300 include injector driver 330 which includes a feedback controller 332 configured to receive ICC 320 as control input, to receive feedback of injector current from current sensor 336, and to output a switch control signal to control switch 334 in response to the received inputs. Feedback controller 332 may be configured as a PID controller, a variant thereof such as a PI controller or a P controller, or another type of feedback controller such as a feedback controller in combination with an open loop controller or control element, and may be implemented via an ASIC, FPGA or other electronic micro-controller. Feedback controller is 310 further configured to provide a signal indicative of the SOH 326 to injector command controls 310.

Switch 334 is operatively coupled with a system voltage source (V_supply) and configured to selectably supply an injector current (I_inj) to a solenoid 124 of an injector 12. The injector current (I_inj) is effective to energize solenoid 124 to induce lifting motion of injector armature 122 (sometimes referred to as an injector needle) in the direction generally indicated by arrow L. In the lifted position (illustrated in phantom as denoted by dashed lines), injector armature 122 allows fuel supplied to injector gallery 126 to exit one or more apertures of a tip of injector 12 as an fuel injection (F_inj) into a corresponding combustion chamber 11 of engine 10.

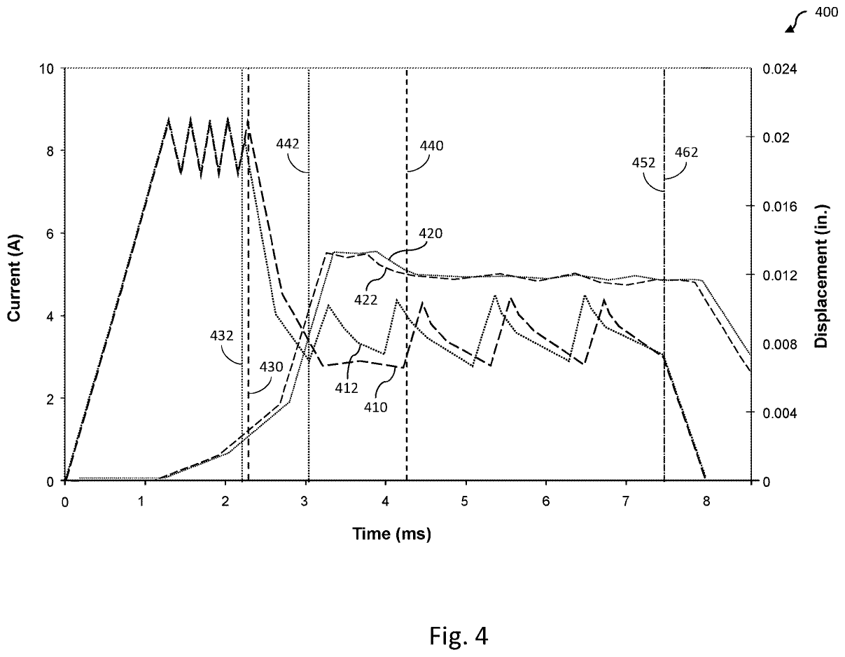

Further aspects of an example injection which may be performed by injector 12 in response to controls 300 and execution of process 200 are illustrated in FIG. 4 which illustrates a graph 400. Graph 400 illustrates injector current waveform 410 and injector current waveform 412 which correspond to current (A) as a function of time (ms) as indicated by the left and bottom scale legends of graph 400. Graph 400 also illustrates injector position waveform 420 and injector position waveform 4220 which correspond to displacement (in.) as a function of time (ms) as indicated by the right and bottom scale legends of graph 400.

During an injection event, injector current waveform 410 and injector current waveform 412 initially ramp up to respective maximum injector currents in response to feedback controller 332 turning switch 334 on. Injector current waveform 410 and injector current waveform 412 are then maintained in a maximum injector current region by a PWM or other feedback control performed by feedback controller 332 over switch 334. During this time injector armature 122 begins to open and approaches a fully open position.

At PIT 430 and PIT 432, respectively, injector current waveform 410 and injector current waveform 412 ramp down from the maximum injector current region in response to feedback controller 332 turning switch 334 off. During this time injector armature 122 continues to open due to its velocity and momentum and achieves a fully open position.

Starting at SOH 440 and SOH 442, respectively, injector current waveform 410 and injector current waveform 412 are maintained at a hold level to maintain an injector armature in an open position in response to a PWM or other feedback control performed by feedback controller 332 over switch 334.

At injector off (IO) time 450 and injector off (IO) time 452 and IO time injector current waveform 410 and injector current waveform 412 decay to zero in response to feedback controller 332 turning switch 334 off. During this time injector armature 122 begins to close and proceeds toward a fully closed position.

By comparing injector current waveform 410 and injector current waveform 412 it can be seen that a small change in PIT (e.g., the change between PIT 430 and PIT 432) produces a much greater changed in SOH (e.g., the change between SOH 440 and SOH 442). In some embodiments this relationship may be described as a discontinuity or near discontinuity in SOH as a function of PIT which may occur in response to a back electromotive force (BEMF signal) delaying SOH if PIT is slightly increased. The compliance of the armature stop, or flexing of the armature itself when the armature hits the stop, can causes the current to rise slightly after armature impact which, in turn, can amplifies the change in SOH.

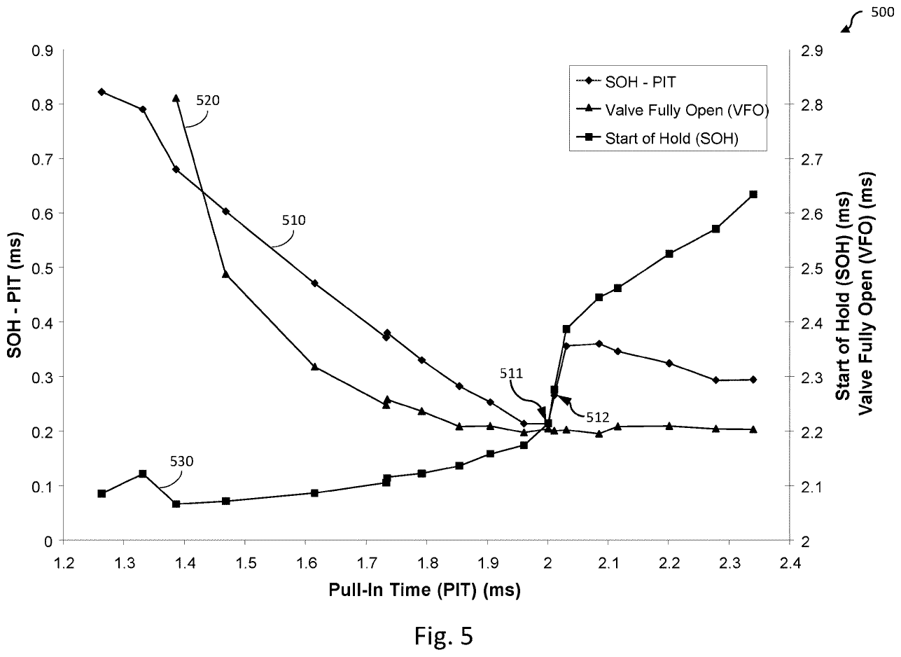

Further aspects of an example control process which may be performed by controls 300 executing process 200 are illustrated in FIG. 5 which illustrates a graph 500. In graph 400, curve 510 illustrates the difference between SOH and PIT (SOH-PIT) as a function of PIT as indicated by the left and bottom scale legends of graph 500. Curve 520 illustrates VFO as a function of PIT as indicated by the right and bottom scale legends of graph 500. Curve 530 illustrating SOH as a function of PIT as indicated by the right and bottom scale legends of graph 500.

The difference between SOH and PIT, i.e., the fall time of the current signal, gives an indication of VFO. As shown in graph 500, the curve 510 (SOH-PIT) steadily falls until the point at which SOH coincides with VFO. Then there is a sharp rise in curve 510 followed by a more gentle decay. The minimum point of curve 510 (SOH-PIT) corresponds to the PIT for which SOH=VFO. A search for VFO can be done by beginning with a small PIT and incrementing it until SOH-PIT rises. When this happens, VFO is equal to SOH from the previous increment. These characteristics may be applied to a control process and controls that utilize the aforementioned change in the difference between SOH and PIT that occurs as a function of PIT and the coincidence of VFO and SOH. As PIT is a commanded value and SOH is monitored as a status feedback to an ECU, so that both are known values and are easily accessed for use by a control process or controls, for example, as described in connection with process 200 and controls 300.

As shown by this detailed description, the present disclosure contemplates multiple and various embodiments, including, without limitation, the following example embodiments. A first example embodiment is a process of operating an electronic control system to control a fueling system, the process comprising: operating a fuel injector to perform an injection in response to an injector control command including a pull in time (PIT); determining a start of hold time (SOH) in response to the operating the fuel injector; calculating a difference between the SOH and the PIT; determining a valve fully open time (VFO) in response to the determining and the calculating; modifying an injector control model based on the VFO; and controlling operation of the fuel injector using the updated injector control model.

A second example embodiment includes the features of the first example embodiment, wherein the determining the VFO in response to the difference comprises: second operating the fuel injector to perform a second injection in response to a second injector control command including a second PIT, the second PIT being greater than the PIT; second calculating a second difference between a second SOH determined in response to the second operating the fuel injector and the second PIT; evaluating the second difference relative to first difference; and if the second difference is greater than the difference, performing the determining the valve VFO based upon the difference.

A third example embodiment includes the features of the second example embodiment, wherein the determining the VFO comprises setting the VFO to equal the SOH.

A fourth example embodiment includes the features of any one of the first through third example embodiments, wherein the updating the injector control model based on the VFO comprises modifying a data structure indicative of an injection quantity.

A fifth example embodiment includes the features of the fourth example embodiment, wherein the data structure maps a plurality of injection quantities to a corresponding plurality of injector control commands.

A sixth example embodiment includes the features of any one of the first through third example embodiments, wherein the PIT establishes a time during the injection for reducing a current of the injector.

A seventh example embodiment includes the features of any one of the first through third example embodiments, wherein the operating a fuel injector to perform the injection comprises operating the fuel injector to inject a gaseous fuel into a combustion cylinder.

An eighth third example embodiment includes the features of the seventh example embodiment, wherein the gaseous fuel comprises one of natural gas and hydrogen.

A ninth example embodiment includes the features of any one of the first through third example embodiments, wherein the controlling operation of the fuel injector using the updated injector control model comprises controlling the fuel injector to perform a fuel injection into a combustion chamber of an engine.

A tenth example embodiment includes the features of the ninth example embodiment, wherein the fuel injection into the combustion chamber is effective to provide traction torque to propel a vehicle.

An eleventh example embodiment is a system comprising: a fueling system including at least one injector; and an electronic control system configured to: operate the fuel injector to perform an injection in response to an injector control command including a pull in time (PIT), determine a start of hold time (SOH) in response to operation of the fuel injector; calculate a difference between the SOH and the PIT, determine a valve fully open time (VFO) in response to the determination and the calculation, modify an injector control model based on the VFO, and control operation of the fuel injector using the updated injector control model.

A twelfth example embodiment includes the features of the eleventh example embodiment, wherein the electronic control system being configured to determine the VFO in response to the difference comprises the electronic control system being configured to: second operate the fuel injector to perform a second injection in response to a second injector control command including a second PIT, the second PIT being greater than the PIT; second calculate a second difference between a second SOH determined in response to the second operating the fuel injector and the second PIT; evaluate the second difference relative to first difference; and if the second difference is greater than the difference, determine the valve VFO based upon the difference.

A thirteenth example embodiment includes the features of the twelfth example embodiment, wherein the electronic control system being configured to determine the VFO comprises the electronic control system being configured to set the VFO to equal the SOH.

A fourteenth example embodiment includes the features of any one of the eleventh through thirteenth example embodiments, comprising the electronic control system being configured to update the injector control model based on the VFO comprises modifying a data structure indicative of an injection quantity.

A fifteenth example embodiment includes the features of the fourteenth example embodiment, wherein the data structure maps a plurality of injection quantities to a corresponding plurality of injector control commands.

A sixteenth example embodiment includes the features of any one of the eleventh through thirteenth example embodiments, wherein the PIT establishes a time during the injection for reducing a current of the injector.

A seventeenth example embodiment includes the features of any one of the eleventh through thirteenth example embodiments, wherein the fuel injector is configured to inject a gaseous fuel into a combustion cylinder.

An eighteenth example embodiment includes the features of the seventeenth example embodiment, wherein the gaseous fuel comprises one of natural gas and hydrogen.

A nineteenth example embodiment includes the features of any one of the eleventh through thirteenth example embodiments, wherein the fuel injector is configured to inject fuel directly into a combustion chamber of an engine.

A twentieth example embodiment includes the features of the nineteenth example embodiment, wherein the fueling system and the electronic control system are operatively coupled with an internal combustion engine configured to one of propel a vehicle and drive a load.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to any of a number of acts, configurations, devices, operations, and techniques, individually or in combination, including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A process of operating an electronic control system to control a fueling system, the process comprising:
operating a fuel injector to perform an injection in response to an injector control command including a pull in time (PIT);
determining a start of hold time (SOH) in response to the operating the fuel injector;
calculating a difference between the SOH and the PIT;
determining a valve fully open time (VFO) in response to the determining and the calculating;
modifying an injector control model based on the VFO; and
controlling operation of the fuel injector using the updated injector control model.

2. The process of claim 1, wherein the determining the VFO in response to the difference comprises:
second operating the fuel injector to perform a second injection in response to a second injector control command including a second PIT, the second PIT being greater than the PIT;
second calculating a second difference between a second SOH determined in response to the second operating the fuel injector and the second PIT;
evaluating the second difference relative to first difference; and
if the second difference is greater than the difference, performing the determining the valve VFO based upon the difference.

3. The process of claim 2, wherein the determining the VFO comprises setting the VFO to equal the SOH.

4. The process of claim 1, wherein the updating the injector control model based on the VFO comprises modifying a data structure indicative of an injection quantity.

5. The process of claim 4, wherein the data structure maps a plurality of injection quantities to a corresponding plurality of injector control commands.

6. The process of claim 1, wherein the PIT establishes a time during the injection for reducing a current of the injector.

7. The process of claim 1, wherein the operating a fuel injector to perform the injection comprises operating the fuel injector to inject a gaseous fuel into a combustion cylinder.

8. The process of claim 7, wherein the gaseous fuel comprises one of natural gas and hydrogen.

9. The process of claim 1, wherein the controlling operation of the fuel injector using the updated injector control model comprises controlling the fuel injector to perform a fuel injection into a combustion chamber of an engine.

10. The process of claim 9, wherein the fuel injection into the combustion chamber is effective to provide traction torque to propel a vehicle.

11. A system comprising:
a fueling system including at least one injector; and
an electronic control system configured to:
operate the fuel injector to perform an injection in response to an injector control command including a pull in time (PIT),
determine a start of hold time (SOH) in response to operation of the fuel injector;
calculate a difference between the SOH and the PIT,
determine a valve fully open time (VFO) in response to the determination and the calculation,
modify an injector control model based on the VFO, and
control operation of the fuel injector using the updated injector control model.

12. The system of claim 11, wherein the electronic control system being configured to determine the VFO in response to the difference comprises the electronic control system being configured to:
second operate the fuel injector to perform a second injection in response to a second injector control command including a second PIT, the second PIT being greater than the PIT;
second calculate a second difference between a second SOH determined in response to the second operating the fuel injector and the second PIT;
evaluate the second difference relative to first difference; and
if the second difference is greater than the difference, determine the valve VFO based upon the difference.

13. The system of claim 12, wherein the electronic control system being configured to determine the VFO comprises the electronic control system being configured to set the VFO to equal the SOH.

14. The system of claim 13, comprising the electronic control system being configured to update the injector control model based on the VFO comprises modifying a data structure indicative of an injection quantity.

15. The system of claim 14, wherein the data structure maps a plurality of injection quantities to a corresponding plurality of injector control commands.

16. The system of claim 13, wherein the PIT establishes a time during the injection for reducing a current of the injector.

17. The system of claim 13, wherein the fuel injector is configured to inject a gaseous fuel into a combustion cylinder.

18. The system of claim 17, wherein the gaseous fuel comprises one of natural gas and hydrogen.

19. The system of claim 13, wherein the fuel injector is configured to inject fuel directly into a combustion chamber of an engine.

20. The system of claim 19, wherein the fueling system and the electronic control system are operatively coupled with an internal combustion engine configured to one of propel a vehicle and drive a load.
